(19) United States
(12) Patent Application Publication
(10) Pub. No.: US 2026/0074528 A1
(43) Pub. Date: Mar. 12, 2026

(54) Tablet to Band Docking and Charging Method

(71) Applicant: Shane Joseph Crew, Pollock Pines, CA (US)

(72) Inventor: Shane Joseph Crew, Pollock Pines, CA (US)

(21) Appl. No.: 19/328,223

(22) Filed: Sep. 14, 2025

(51) Int. Cl. H02J 7/34; G06F 1/26; G06F 1/28; G08B 21/24; H02J 7/00; H02J 50/10; H02J 50/60

(52) U.S. Cl. CPC H02J 7/342; G06F 1/266; G06F 1/28; G08B 21/24; H02J 7/42; H02J 7/65; H02J 7/731; H02J 7/92; H02J 50/10; H02J 50/60

(57) ABSTRACT

A method of operating a wearable monitoring system in which a tablet or smartphone-sized device directly charges a wristband without separate cords or swappable batteries. The method includes prompting docking based on a low wristband battery or a scheduled charging window, maintaining the tablet's full usability while docked, and charging via inductive power transfer (without exposed contacts) or via conductive interfaces (pins or surface pads). Retention may be magnetic, mechanical, or combinations thereof. The method improves charging compliance, ingress protection, tamper resistance and safety.

### CROSS-REFERENCE TO RELATED APPLICATIONS

This application is a Continuation-in-Part (CIP) of U.S. patent application Ser. No. 18/386,201, filed Nov. 1, 2023, entitled “Tracking Behavior Modification System and Associated Methods.” The disclosure of the parent application is incorporated herein by reference in its entirety.

### STATEMENT REGARDING FEDERALLY SPONSORED RESEARCH OR DEVELOPMENT

None.

### FIELD OF THE INVENTION

The present disclosure relates to wearable monitoring systems and, more particularly, to methods for operating such systems so that a tablet directly recharges a wristband without cords or swappable batteries while the tablet remains fully usable.

### BACKGROUND

Wearable monitoring in controlled environments benefits from reliable charging without accessories that can be tampered with or misplaced. Cables and removable batteries raise safety and compliance concerns. There is a need for a method that integrates charging into routine use by docking a tablet directly to a wristband, maintaining tablet usability, and prompting users at appropriate times to ensure compliance.

### SUMMARY

Disclosed is a method of operating a wearable monitoring system comprising steps to (i) determine when the wristband requires charge, (ii) prompt the user to dock the tablet to the wristband either on low battery or per a scheduled window, (iii) authenticate the wristband, and (iv) charge the wristband from the tablet while keeping the tablet fully usable. The method supports inductive power transfer (no exposed contacts) and conductive interfaces (pins or surface pads). Physical retention during the method may be provided by magnetic coupling, mechanical latch mechanisms (e.g., cam, snap-fit, bayonet, threaded), or combinations thereof.

### BRIEF DESCRIPTION OF THE DRAWINGS

FIG. 1 is a flow diagram illustrating the operational sequence of the tablet-to-wristband docking and charging process. The steps include detecting a need for charging, prompting the user to dock the device, docking the device, authenticating the connection, maintaining charging while the tablet remains usable, and confirming successful charging.

FIG. 2 is a block diagram illustrating the electrical relationship between the tablet and the wristband. The tablet includes a controller and power-management circuitry that interfaces with an inductive driver or pin-pad connection at the docking point, while the wristband includes a rechargeable battery and charge-management circuitry configured to receive power from the tablet when docked.

FIG. 3 is a diagram illustrating a low-battery alert and scheduling interface between the wristband and the tablet. The wristband transmits a wireless low-battery warning to the tablet, which displays selectable docking time slots and a confirmation prompt to schedule charging.

FIG. 4 is a timing diagram illustrating the scheduling of docking and charging windows between the tablet and wristband. The diagram shows scheduled time intervals during which the wristband can dock with the tablet for charging, as well as a detected low-battery event occurring between the scheduled charging windows.

FIG. 5 is a sequence diagram illustrating the authentication and charging control process between the tablet and the wristband. The tablet issues an authentication request to the wristband, which responds to a challenge message. Based on the authentication result, the system either disables charging upon failure or enables full-rate charging until the wristband battery is fully charged.

FIG. 6 is a perspective view showing the tablet docked to the wristband while worn on a user's arm. The figure illustrates the physical arrangement of the tablet and wristband during charging, with the tablet remaining operable while magnetically or mechanically coupled to the wristband.

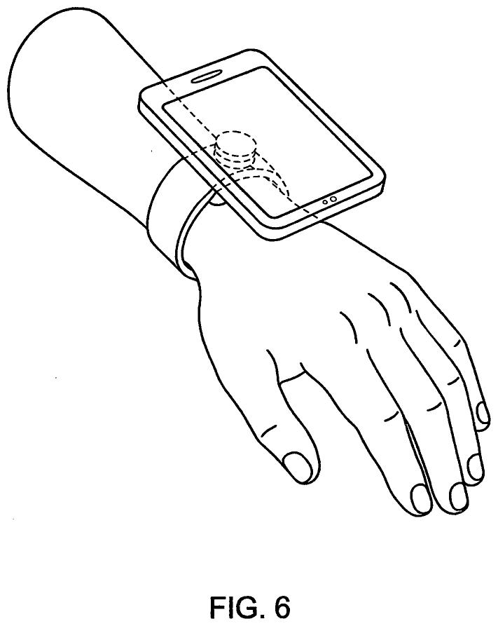

### DETAILED DESCRIPTION

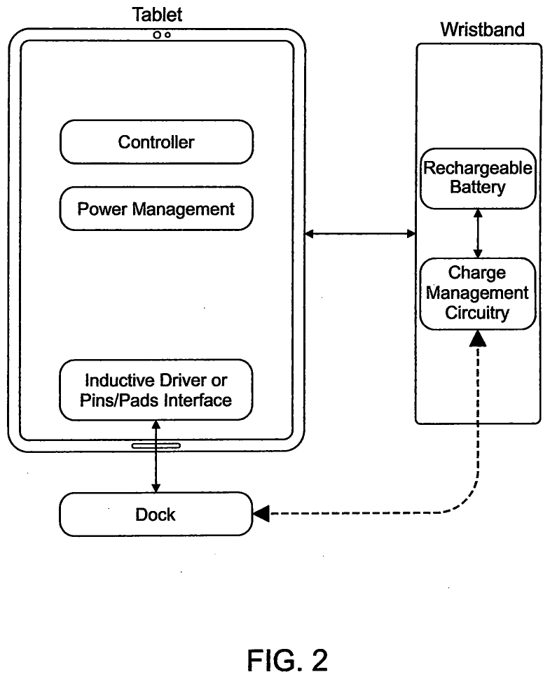

System Context (FIG. 2). A tablet device cooperates with a wristband. The tablet includes a controller and power management that, when docked, supply charging power. The wristband includes a rechargeable battery and charge-management circuitry.

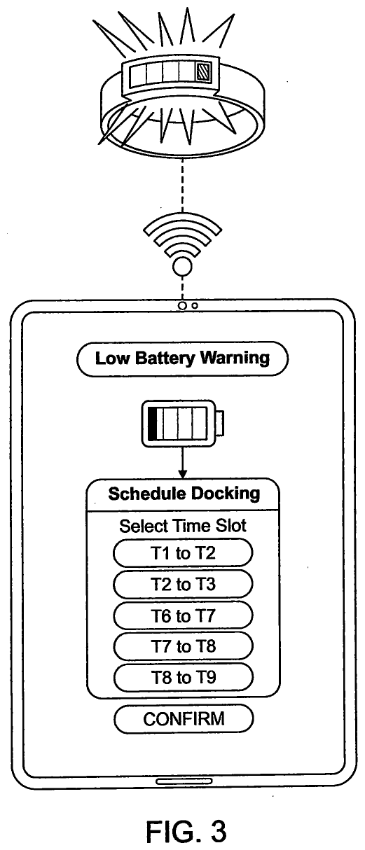

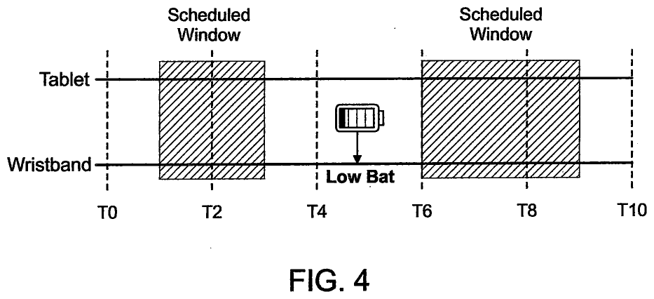

Charging Interfaces (FIGS. 2-4). In an inductive embodiment, a primary coil in the tablet energizes a secondary coil in the wristband; the received power is rectified and conditioned to charge the battery. Inductive charging excludes exposed electrical contacts, supporting higher ingress protection and tamper resistance. In conductive embodiments, power is transferred through spring-biased pins engaging landing pads or via conductive surface pads across a compliant interface; contact regions can be recessed or shrouded to inhibit probing and fluid ingress.

Retention During Docking (FIGS. 2-4). Retention may be magnetic, mechanical (cam, bayonet, snap-fit, spring clip, threaded collar), or magnet-plus-latch combinations. A magnet-only variant is contemplated.

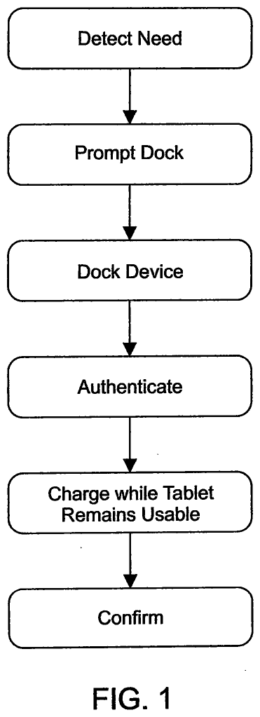

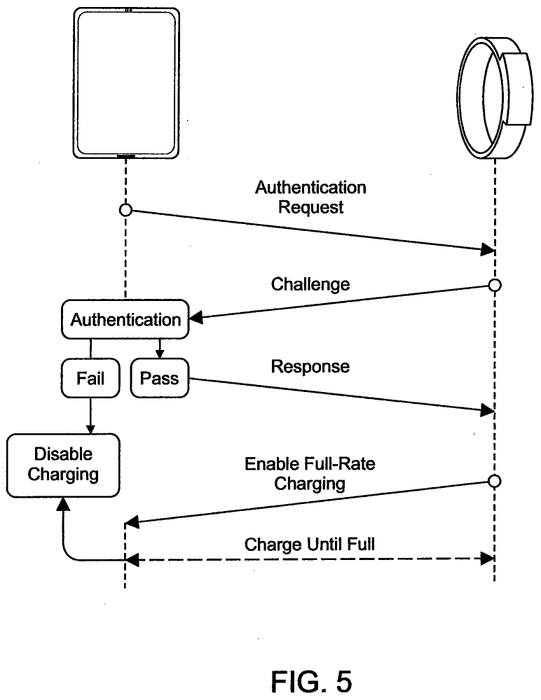

Prompts, Scheduling, and Authentication (FIGS. 1, 3, 5). The method includes generating a prompt to dock based on a detected low-battery state or a scheduled charging period. Optionally, the wristband is authenticated before enabling full-rate charging, and successful docking is confirmed by detecting stable retention and/or a digital handshake.

Continuous Usability (FIG. 1). Throughout charging, the tablet remains fully functional for interaction, communication, and display. Optional tamper detection may log forced separation or probing, trigger alarms, and derate/disable charging upon unsafe conditions such as foreign-object detection or over-temperature.

Non-Limiting Nature. Steps can be re-ordered, combined, or omitted. Any retention option can be paired with any power-transfer option.

1. A method of operating a wearable monitoring system comprising a wristband and a tablet computing device, the method comprising: detecting a need to charge a battery of the wristband; prompting a user to dock the tablet to the wristband based on at least one of a detected low-battery state of the wristband or a scheduled charging period; docking the tablet to the wristband; charging, by the tablet, the battery of the wristband while maintaining the tablet fully usable for user interaction; and confirming successful docking.

2. The method of claim 1, further comprising authenticating the wristband prior to enabling charging.

3. The method of claim 1, wherein charging is performed by inductive power transfer and excludes exposed electrical contacts.

4. The method of claim 1, wherein charging is performed via electrical pins engaging landing pads.

5. The method of claim 1, wherein charging is performed via conductive surface pads across a compliant interface.

6. The method of claim 1, wherein retention during docking is provided solely by magnetic coupling without a mechanical latch.

7. The method of claim 1, wherein retention during docking is provided solely by a mechanical latch without magnetic coupling.

8. The method of claim 1, wherein retention during docking is provided by magnetic coupling in combination with a mechanical latch.

9. The method of claim 8, wherein the mechanical latch comprises at least one of: cam lock, bayonet coupling, snap-fit, spring clip, or threaded collar.

10. The method of claim 1, further comprising tamper detection of forced separation or probing and generating an alert responsive to detected tamper.

11. The method of claim 1, further comprising derating or disabling charging upon detection of a foreign object or an over-temperature condition.

12. The method of claim 1, wherein prompting includes escalating notifications when a scheduled charging period is missed.

13. The method of claim 1, wherein confirming successful docking includes detecting at least one of: a stable retention state, satisfactory coupling for power transfer, contact impedance within a threshold, or receipt of an acknowledgment message.

14. The method of claim 1, wherein docking is tool-less and configured for one-handed operation by the user.

15. The method of claim 1, further comprising maintaining sealed external surfaces at a docking region to improve ingress protection and tamper resistance.

16. A wearable monitoring system configured to perform the method of claim 1, comprising a wristband with a rechargeable battery and a tablet computing device that, when docked, charges the wristband battery while remaining fully usable.

17. A non-transitory computer-readable medium storing instructions that, when executed by one or more processors of the tablet and/or the wristband, cause performance of the method of any one of claims 1 through 15.
